(19) United States
(12) Patent Application Publication
(10) Pub. No.: US 2021/0373171 A1
(43) Pub. Date: Dec. 2, 2021

(54) LIDAR SYSTEM

(71) Applicant: Robert Bosch GmbH, Stuttgart (DE)

(72) Inventors: Siegwart Bogatscher, Leonberg (DE); Alexander Greiner, Reichenbach (DE); Florian Mauch, Talheim (DE)

(21) Appl. No.: 17/329,013

(22) Filed: May 24, 2021

(30) Foreign Application Priority Data
May 29, 2020 (DE) 10 2020 206 817.8

(51) Int. Cl. G01S 17/931; G01S 17/89; G01S 7/481

(52) U.S. Cl. CPC G01S 17/931; G01S 7/4817; G01S 7/4811; G01S 17/89

(57) ABSTRACT

A LIDAR system, which includes both a video sensor and a LIDAR sensor in a receive path. The LIDAR system includes a rotatable mirror in the receive path to deflect light incident in the LIDAR system to the video sensor and/or to the LIDAR sensor.

### CROSS REFERENCE

The present application claims the benefit under 35 U.S.C. § 119 of German Patent Application No. DE 102020206817.8 filed on May 29, 2020, which is expressly incorporated herein by reference in its entirety.

The present invention relates to a LIDAR system, which includes both a video sensor and a LIDAR sensor in a receive path.

### BACKGROUND INFORMATION

In typical highly automated vehicles, video data are fused with LIDAR point cloud data to achieve reliable object detections. For this purpose, video sensors and LIDAR sensors are typically integrated into the vehicle separately from one another. Complex roof boxes often have to be constructed for this purpose. Moreover, the video sensors have to be calibrated in relation to the LIDAR sensors. A long tolerance chain results due to the separate vehicle integration. A further disadvantage which results due to the separate vehicle integration is that both sensor types necessarily have different sensor coordinate systems having different view angles into the surroundings. This requires extremely complex conversions of the raw data before a fusion of the particular data may be carried out.

PCT Patent Application No. WO 2014/040 081 A1 describes a LIDAR system including a combination of depth camera and image camera. The document describes that these two camera/sensor systems may be housed in a single module with the aid of a rotatable mirror in the reception beam path.

European Patent Application No. EP 3 460 520 A1 describes a multibeam laser scanner for a LIDAR system. A rotatable mirror is provided in the reception beam path. The rotatable mirror deflects the reception beam onto a plurality of photodetectors through a central focusing optical unit.

A LIDAR system is described in PCT Patent Application No. WO 2017/106 875 A1, in which a rotatable mirror in the emission beam path is configured to scan a field of view using a light beam.

PCT Patent Application No. WO 2016/126 297 A1 shows and describes a mobile security robot, in which a rotatable mirror is provided in the reception beam path to expand a field of view of an image sensor.

### SUMMARY

According to the present invention, a LIDAR system is provided which includes a rotatable mirror in the receive path to deflect light incident in the LIDAR system to the video sensor and/or to the LIDAR sensor.

The LIDAR system has the advantage that the tolerance chain between video sensor and LIDAR sensor is minimized. Moreover, a vehicle integration is only carried out once, which results in a cost savings. Possible vibrations or impacts which act on the rotatable mirror due to the mounting play moreover act in the same way on both sensors. The objects to be recognized are additionally always located at the same position for both sensors at the measurement time, by which a high correlation of the measured data of both sensors is provided.

In some specific embodiments of the present invention, the LIDAR sensor, the video sensor, and the rotatable mirror are installed in a shared housing. A compact unit may thus be provided, which may record both video data and LIDAR data.

Some specific embodiments of the present invention provide that the rotatable mirror has a first operating position, in which it is situated to deflect the incident light to the LIDAR sensor, and has a second operating position, in which it is situated to deflect the incident light to the video sensor. The incident light may thus be supplied selectively to either the LIDAR sensor or the video sensor.

Other specific embodiments of the present invention provide that the rotatable mirror has the first operating position, in which it is situated to deflect the incident light to both the LIDAR sensor and the video sensor, and has the second operating position, to interrupt the receive path to both the LIDAR sensor and the video sensor. Thus, in the first operating position, the incident light may be deflected at the same time to both the LIDAR sensor and the video sensor, and, in the second operating position, the receive path may be interrupted at the same time for both the LIDAR sensor and the video sensor.

In accordance with an example embodiment of the present invention, the LIDAR system preferably includes a dichroic mirror. Visible wavelengths of the incident light, which are suitable for the video sensor, may thus be separated from infrared wavelengths, which are suitable for the LIDAR sensor. The dichroic mirror may be a static mirror, which may be situated in the receive path between the rotatable mirror and the video sensor and between the rotatable mirror and the LIDAR sensor. In some specific embodiments, the rotatable mirror is the dichroic mirror. In specific embodiments of the present invention, the video sensor is a camera which is configured to record still images and/or moving images as sensor data from the incident light. It may therefore be reasonable to deflect visible wavelengths of the incident light onto the video sensor.

In specific embodiments of the present invention, the LIDAR sensor is a laser sensor which is configured to accommodate infrared light, preferably to generate point cloud data, in particular 3D point cloud data, from the incident light. It may therefore be reasonable to deflect infrared wavelengths of the incident light onto the LIDAR sensor.

It is preferred that the LIDAR system includes at least one laser source. The at least one laser source is particularly preferably situated laterally offset in relation to the LIDAR sensor. The LIDAR sensor is thus not shaded by the light source in the receive path, as would be the case if the laser source were situated in the receive path in front of the LIDAR sensor, but not laterally offset. The laser source is preferably an infrared laser. The laser source is configured to emit light into the surroundings which subsequently, after reflection on an object in the surroundings, enters as part of the incident light back into the LIDAR system.

In some specific embodiments of the present invention, the at least one laser source, the LIDAR sensor, and the video sensor are situated on the same side in relation to the rotatable mirror. A simultaneous measurement of distance, grayscale, and color information of objects is thus enabled. A particularly compact construction of the LIDAR sensor may also be enabled. Such an arrangement may be achieved particularly advantageously if the LIDAR system includes the dichroic mirror. However, it is provided in some alternative specific embodiments of the present invention that the LIDAR sensor and the at least one laser source are situated on one side of the rotatable mirror, while the video sensor is situated on another side of the rotatable mirror. A dichroic mirror may then advantageously be omitted, because the visible wavelengths and the infrared wavelengths do not have to be separated out of the incident light, but rather simply all of the incident light may be deflected either to the video sensor or to the LIDAR sensor.

In some specific embodiments of the present invention, the LIDAR system includes two or more laser sources, which are situated on opposite sides of the LIDAR sensor, each laterally from the LIDAR sensor. Therefore, laser sources are preferably also detected which are situated above and below the LIDAR sensor. A redundancy may thus be provided for malfunctions of one of the two or more laser sources or an amplified beam power may be achieved in the case of simultaneous operation of multiple laser sources. If the multiple laser sources are located as proposed on opposite sides, they may neither mutually negatively affect one another, nor shade the LIDAR sensor. It is preferable that each laser source is oriented with its active side counter to the receiving direction of the LIDAR sensor, and thus is situated to emit counter to the light incident on the LIDAR sensor.

It is preferred that the video sensor is situated to receive the incident light directly from the rotatable mirror. A simplified structure of the LIDAR sensor may thus be achieved, because additional deflection mirrors become superfluous.

Alternatively, some specific embodiments of the present invention provide that the video sensor is situated to receive the incident light from the rotatable mirror via two or more static mirrors, which are situated in the receive path between the rotatable mirror and the video sensor. This permits more compact implementation options for the LIDAR system, because video sensor and LIDAR sensor may be situated more compactly.

Some alternative specific embodiments provide, however, that the video sensor is situated to receive the incident light from the rotatable mirror via only one single static mirror, which is situated in the receive path between the rotatable mirror and the video sensor. This may be a good compromise between the use of two or more static mirrors and direct reception from the rotatable mirror. The one static mirror may be, but does not have to be, the dichroic mirror.

In accordance with an example embodiment of the present invention, the video sensor and the LIDAR sensor are preferably configured to use a shared sensor coordinate system. The raw data of both sensors then no longer have to be converted in an extremely complex manner before a fusion may be carried out. This may save computing power and accelerate the mode of operation of the LIDAR sensor or reduce the manufacturing costs. The shared sensor coordinate system may particularly advantageously be enabled in that both the video sensor and the LIDAR sensor are integrated into the LIDAR system.

Some specific embodiments of the present invention provide that the LIDAR system is configured to mutually check a soiling of the LIDAR system for plausibility using recorded data of both the video sensor and the LIDAR sensor. The LIDAR system is preferably configured to recognize a soiling of a front pane of the LIDAR system and to check this for plausibility by comparing the particular recorded data of the video sensor and the LIDAR sensor. For example, if both sensors do not receive a signal, strong soiling of the front pane may be determined to be plausible. A suspected soiling, which is suspected, for example, due to poor raw data of the LIDAR sensor, may thus be checked for plausibility, which permits more reliable recognition of the soiling.

Furthermore, in accordance with an example embodiment of the present invention, a vehicle is preferably provided, which includes a LIDAR system mentioned at the outset. It is preferred that the LIDAR system is operationally connected to a battery of the vehicle to operate the LIDAR system. The LIDAR system preferably includes a rotatable mirror in the receive path to deflect the light incident in the LIDAR system to the video sensor and/or to the LIDAR sensor.

The vehicle may be a motor vehicle, in particular a road motor vehicle, for example a passenger vehicle or a truck or a two-wheeler. Other specific embodiments of vehicles are aircraft, preferably automated flying taxis and drones.

Further possible specific embodiments of the vehicle of the present invention and its advantages result, mutatis mutandis, from the above-described specific embodiments of the LIDAR system, so that repetitions will be omitted at this point.

Advantageous refinements of the present invention are disclosed herein.

### BRIEF DESCRIPTION OF THE DRAWINGS

Exemplary embodiments of the present invention are explained in greater detail on the basis of the figures and the following description.

FIG. 1 shows a vehicle which includes a LIDAR system according to a first specific example embodiment of the present invention.

FIG. 2 shows the LIDAR system according to the specific example embodiment from FIG. 1 in a first operating state.

FIG. 3 shows the LIDAR system according to the specific example embodiment from FIG. 1 in a second operating state.

FIG. 4 shows a LIDAR system according to a second specific example embodiment of the present invention in a first operating state.

FIG. 5 shows a LIDAR system according to a third specific example embodiment of the present invention in a first operating state.

FIG. 6 shows a LIDAR system according to a fourth specific example embodiment of the present invention in a first operating state.

### DETAILED DESCRIPTION OF EXAMPLE EMBODIMENTS

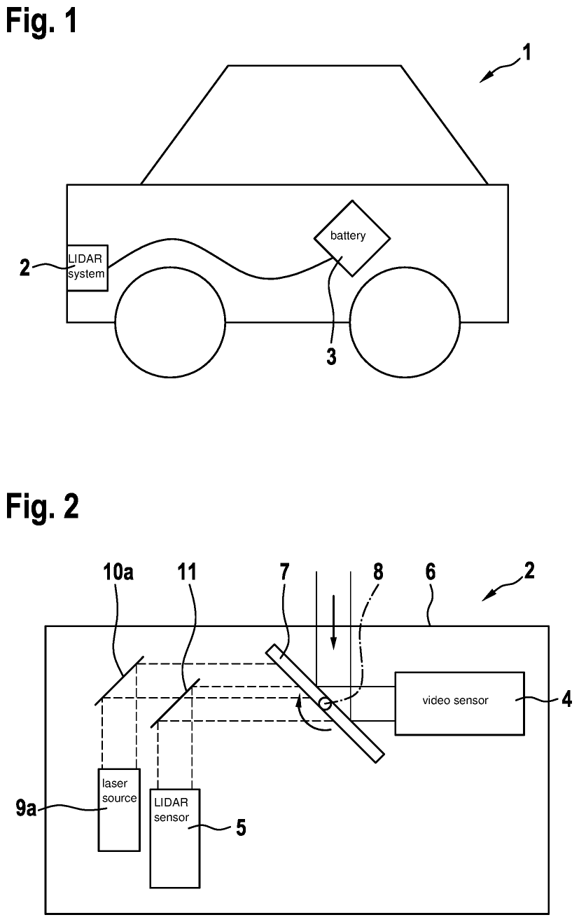

FIG. 1 shows a vehicle 1, which includes a LIDAR system 2 in a specific embodiment according to the present invention. LIDAR system 2 is operationally connected to a battery 3 of vehicle 1 in order to operate LIDAR system 2. Vehicle 1 is a road vehicle, especially an autonomously driving passenger vehicle here.

In FIG. 2, LIDAR system 2 from FIG. 1 is illustrated in a simplified top view, in fact in a first operating state. LIDAR system 2 includes both a video sensor 4 and a LIDAR sensor 5 in a receive path. Video sensor 4 and LIDAR sensor 5 are installed in a shared housing 6. LIDAR system 2 includes a rotatable mirror 7 in the receive path. Rotatable mirror 7 is also installed in housing 6. Rotatable mirror 7 is rotatable around a rotational axis 8 between two different operating positions, which define the possible operating states of LIDAR system 2. LIDAR system 2 is thus configured to deflect incident light either to video sensor 4 or LIDAR sensor 5. In the operating position shown, LIDAR system 2 is in a first operating state, in which video sensor 4 is in operation and the incident light is deflected by rotatable mirror 7 to video sensor 4. The position of rotatable mirror 7 is a 0° position for video in this operating position. Video sensor 4 is situated to receive the incident light directly from rotatable mirror 7, thus without further mirrors interposed in the receive path. The incident light includes visible light in this case, which is incident from the surroundings in LIDAR system 2 and may then be recorded as image data by video sensor 4. This specific embodiment is thus a possible implementation of the present invention which manages without static deflection mirrors for video sensor 4.

LIDAR system 2 furthermore includes, as is also apparent in FIG. 2, a laser source 9a, which is situated laterally offset to LIDAR sensor 2. An emission direction of laser source 9a and a reception direction of LIDAR sensor 2 are perpendicular to a reception direction of video sensor 4.

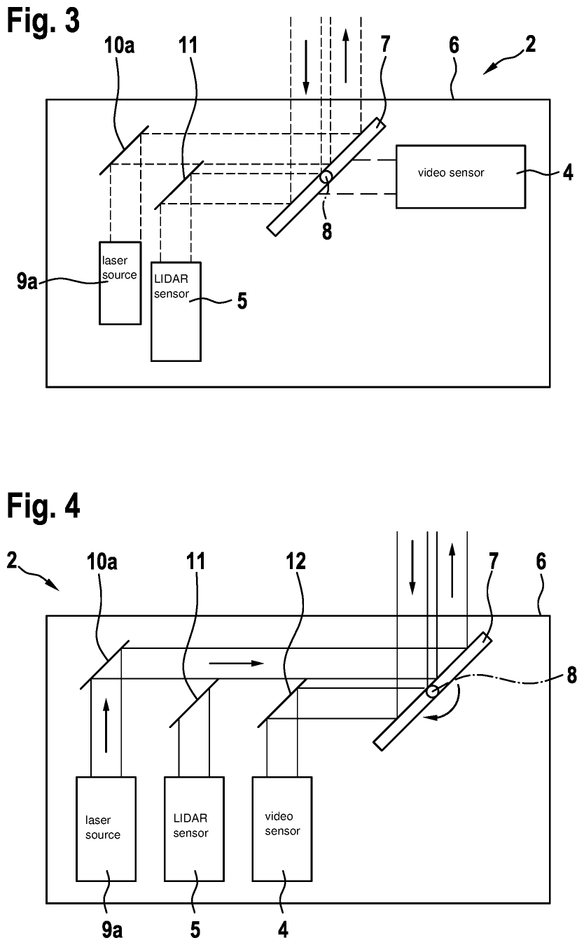

FIG. 3 shows a second operating state of the first specific embodiment. Rotatable mirror 7 is rotated around the rotational axis 8 into a second operating position to deflect light incident in LIDAR system 2 to LIDAR sensor 5. The position of rotatable mirror 7 is a 0° position for LIDAR in this operating position. The incident light is in this case additionally the light which may be emitted by laser source 9a via a first static mirror 10a onto rotatable mirror 7 and from there into surroundings of LIDAR system 2 and is reflected there from an object back to LIDAR system 2. First static mirror 10a is situated to deflect the light coming from laser source 9a by 90° and pass it onto rotatable mirror 7. Rotatable mirror 7 is thus situated here by way of example not only in the receive path, but also in a transmit path of LIDAR system 2. A second static mirror 11 is situated to deflect the incident light which was reflected by rotatable mirror 7 by 90° and pass it on to LIDAR sensor 5. Rotatable mirror 7 is also situated to deflect the light incident thereon, both coming from laser source 9a and also going to LIDAR sensor 5, by 90° in each case.

FIG. 4 shows a second specific embodiment of LIDAR system 2, which may alternatively be installed in vehicle 1. LIDAR system 2 has a rotatable mirror 7 in the receive path, in order, in a first operating position shown, to deflect light incident in LIDAR system 2 to video sensor 4 and to LIDAR sensor 5. In addition to first static mirror 10a and second static mirror 11, a third static mirror 12 is provided, which is a dichroic mirror. The dichroic mirror is situated to separate in the incident light visible light from infrared light, to deflect the visible light to video sensor 4, and to let through to LIDAR sensor 5 the infrared light, which was emitted by laser source 9a into the surroundings and reflected from there back into LIDAR system 2. The infrared light let through is deflected by second static mirror 11, namely in this specific embodiment by 90°, to impact LIDAR sensor 5. Laser source 9a, LIDAR sensor 5, and video sensor 4 are thus situated on the same side in relation to the rotatable mirror. In this exemplary embodiment, the sequence mentioned is sorted by decreasing distance to rotatable mirror 7. By rotating rotatable mirror 7 out of the first operating position shown into a second operating position (not shown), the receive path for both sensors 4, 5 may be interrupted simultaneously, which, if needed, enables simple and rapid interruption of the inflow of incident light.

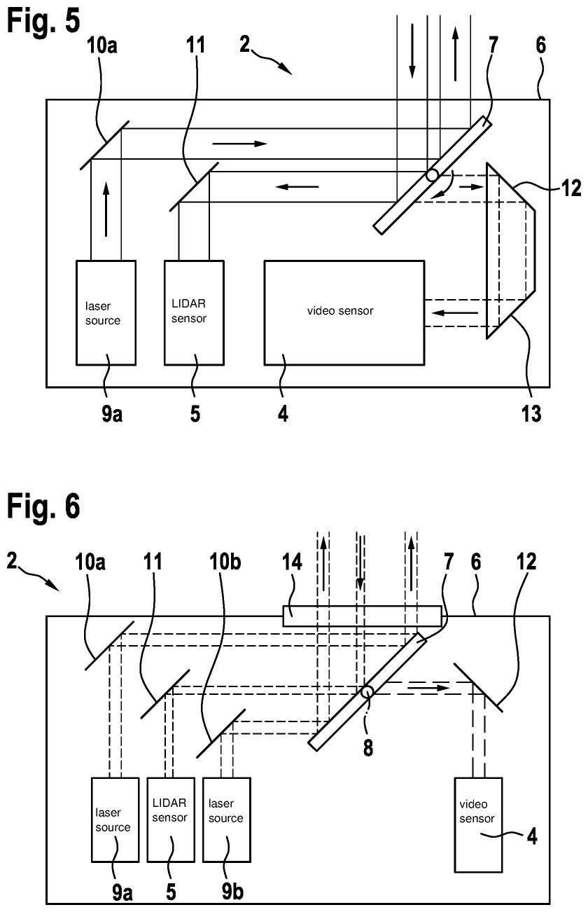

FIG. 5 shows a third specific embodiment of LIDAR system 2, which may alternatively be installed in vehicle 1 from FIG. 1. Rotatable mirror 7 is again situated here to deflect incident light to video sensor 4 or to LIDAR sensor 5. A first operating position is shown in which rotatable mirror 7 deflects incident light to LIDAR sensor 5. Video sensor 4 is situated in this exemplary embodiment, in a second operating position (not shown) of rotatable mirror 7, to receive the incident light from rotatable mirror 7 via a plurality of static mirrors 12, 13, via third static mirror 12 and a fourth static mirror 13 here. In this specific embodiment, third static mirror 12 is not a dichroic mirror, since the light beam does not have to be separated according to wavelength ranges due to the arrangement of video sensor 4 and LIDAR sensor 5 on different sides in relation to rotatable mirror 7. Third static mirror 12 and fourth static mirror 13 are situated to deflect light coming from rotatable mirror 7 by 90° in each case, so that the incident light is deflected in total by 180° and guided onto video sensor 4. A very compact construction of LIDAR sensor 5 is thus achieved. It is thus possible to manage with little installation space using this specific embodiment in that after rotatable mirror 7, an additional twofold deflection of the incident light to video sensor 4 takes place.

Finally, FIG. 6 shows a fourth specific embodiment of LIDAR system 2, which may alternatively be installed in vehicle 1 from FIG. 1. This specific embodiment also again includes rotatable mirror 7 to deflect light incident in LIDAR system 2 to video sensor 4 or to LIDAR sensor 5. In the operating position shown of rotatable mirror 7, rotatable mirror 7 is situated to deflect the incident light onto LIDAR sensor 5. Therefore, incident light does not run on the receive path between rotatable mirror 7 and video sensor 4 via third static mirror 12, which is again not a dichroic mirror here due to the arrangement of video sensor 4 and LIDAR sensor 5 on different sides in relation to rotatable mirror 7. In this specific embodiment, LIDAR system 2 includes a plurality of laser sources 9a, b, namely precisely two here, which are each situated laterally to LIDAR sensor 5 on opposite sides of LIDAR sensor 5. The vertical resolution of the image information first takes place on the detector side, the horizontal resolution materializing due to the scanning procedure of rotatable mirror 7. The illumination of the surroundings by the transmit path may be implemented either by one or by multiple transmit modules, thus the two laser sources 9, which illuminate the vertical field of view by way of one or multiple pulsed transmission beams. In the operating position shown, rotatable mirror 7 is situated to deflect the light of the two laser sources 9a, b into the surroundings, the light initially being deflected via particular first static mirror 10a, b by 90° before it impacts rotatable mirror 7. Furthermore, rotatable mirror 7 is situated in the operating position shown to deflect the light incident from the surroundings via second static mirror 11, for example at a 90° angle, onto LIDAR sensor 5. In this specific embodiment, a front pane 14 of LIDAR system 2 is also illustrated, which is installed in housing 6. LIDAR system 2 is configured, with the aid of a control unit (not shown), to mutually check for plausibility a soiling of LIDAR system 2, in particular front pane 14 of LIDAR system 2, using recorded data of both video sensor 4 and also LIDAR sensor 5.

It is apparent on the basis of the exemplary embodiments shown that LIDAR system 2 permits an integration of video sensor 4 and LIDAR sensor 5 in a shared LIDAR system 2 on the basis of a rotatable mirror 7. In all exemplary embodiments shown, video sensor 4 and LIDAR sensor 5 are configured to use a shared sensor coordinate system in that depending on the operating position of rotatable mirror 7, they have the same incident light supplied to them, which enters from the surroundings into the receive path of LIDAR system 2, simultaneously or selectively depending on the specific embodiment. Due to the shared use of rotatable mirror 7, a shared reference coordinate system for all measured data is thus provided for video sensor 4 and LIDAR sensor 5. The separation of the receive path between video sensor 4 and LIDAR sensor 5 is carried out either by a dichroic mirror, as illustrated on the basis of FIG. 4, or in that both sensors 4, 5 are positioned on the opposite sides of rotatable mirror 7, as illustrated on the basis of FIGS. 2, 3, 5, and 6.

Advantages of the present invention over the related art may include, depending on the implemented specific embodiment, a flat structure, i.e., video sensor 4 no longer has to be installed above LIDAR sensor 5, which results in a simplified vehicle integration, the vehicle integration only takes place once, which is accompanied by a cost savings, or the mechanical tolerance chain between video sensor 4 and LIDAR sensor 5 is significantly shortened. Moreover, a vertical or horizontal offset is possibly no longer present between video sensor 4 and LIDAR sensor 5, thus a shared sensor coordinate system is usable, video sensor 4 and LIDAR sensor 5 may be calibrated in relation to one another (fixed pixel-to-pixel association), and a frame rate does not necessarily have to be synchronized between video sensor 4 and LIDAR sensor 5. Furthermore, video sensor 4 does not require a large horizontal field of view, due to which the objective may be simpler and an imager may be smaller, which may result in a cost savings. In some specific embodiments, the LIDAR objective may even be identical to the video objective if, for example, the objective is situated between front pane 14 and rotatable mirror 7 or is integrated into front pane 14. In one preferred specific embodiment, video sensor 4 and LIDAR sensor 5 measure simultaneously in the same area of the field of view, preferably in the specific embodiment according to FIG. 4. In addition, pieces of angle information only have to be transferred once to a data interface of LIDAR system 2, which facilitates the data processing.

Although the present invention was illustrated and described in detail by preferred exemplary embodiments, thus the present invention is not restricted by the described examples and other variations may be derived therefrom by those skilled in the art, in view of the disclosure herein, without departing from the scope of protection of the present invention.

1-9. (canceled)

10. A LIDAR system, comprising:
a video sensor and a LIDAR sensor, both the video sensor and the LIDAR sensor in a receive path;
a rotatable mirror in the receive path to deflect light incident in the LIDAR system to the video sensor and/or to the LIDAR sensor.

11. The LIDAR system as recited in claim 10, wherein the LIDAR system includes a dichroic mirror.

12. The LIDAR system as recited in claim 10, further comprising:
at least one laser source which is situated laterally offset to the LIDAR sensor.

13. The LIDAR system as recited in claim 12, wherein the at least one laser source, the LIDAR sensor, and the video sensor, are situated on the same side in relation to the rotatable mirror.

14. The LIDAR system as recited in claim 12, wherein the at least one laser source includes two or more laser sources, which are situated on opposite sides of the LIDAR sensor, in each case laterally from the LIDAR sensor.

15. The LIDAR system as recited in claim 10, wherein the video sensor is situated to receive the incident light directly from the rotatable mirror.

16. The LIDAR system as recited in claim 10, wherein the video sensor is situated to receive the incident light from the rotatable mirror via two or more static mirrors, which are situated in the receive path between the rotatable mirror and the video sensor.

17. The LIDAR system as recited in claim 10, wherein the video sensor and the LIDAR sensor are configured to use a shared sensor coordinate system.

18. The LIDAR system as recited in claim 10, wherein the LIDAR system is configured to mutually check for plausibility a soiling of the LIDAR system using recorded data of both the video sensor and the LIDAR sensor.
